(19) United States
(12) Patent Application Publication
(10) Pub. No.: US 2026/0290068 A1
(43) Pub. Date: Sep. 24, 2026

(54) DISPLAY PANEL AND MANUFACTURING METHOD THEREFOR, AND DISPLAY APPARATUS

(71) Applicants: Beijing BOE Technology Development Co., Ltd., Beijing (CN); BOE Technology Group Co., Ltd., Beijing (CN)

(72) Inventors: Yanling HAN, Beijing (CN); Lei WANG, Beijing (CN); Wenqu LIU, Beijing (CN); Jianqing RAN, Beijing (CN); Yupeng ZHAO, Beijing (CN); Yonggang CAO, Beijing (CN); Yue GOU, Beijing (CN); Yaqian JI, Beijing (CN)

(21) Appl. No.: 19/477,437

(22) PCT Filed: Oct. 30, 2023
(86) PCT No.: PCT/CN2023/127698

§ 371 Date: Oct. 21, 2025

(51) Int. Cl. G06V 40/13; G06F 3/041; G06F 3/043

(52) U.S. Cl. CPC G06V 40/1306; G06F 3/0412; G06F 3/043; G06F 2203/04103

(57) ABSTRACT

The present disclosure provides a display panel and a manufacturing method therefor, and a display apparatus. The display panel includes: a display substrate, an ultrasonic transducer, and an acoustic matching layer. The display substrate includes a support layer and a display layer located on the support layer. The ultrasonic transducer is located on the side of the support layer facing away from the display layer. The ultrasonic transducer includes a vibration cavity and a vibration portion, the vibration portion being located between the vibration cavity and the support layer. The acoustic matching layer is located between the vibration portion and the support layer.

### TECHNICAL FIELD

The present disclosure relates to the field of display technology, and in particular to a display panel and a manufacturing method therefor, and a display apparatus.

### BACKGROUND

Fingerprint recognition technology is widely used in mobile terminals such as mobile phones and tablets, as well as in security protection fields such as access control systems and safes. At present, the main ways to realize fingerprint collection in fingerprint recognition technology are optical, capacitive and ultrasonic imaging. Among them, the fingerprint collection of ultrasonic fingerprint recognition technology has 3D characteristics, and the user's finger does not need to touch the fingerprint collection device, which can improve the security of recognition and the user's experience.

Existing ultrasonic fingerprint recognition technology usually uses bulk piezoelectric ultrasonic transducers. Traditional bulk piezoelectric materials use piezoelectric ceramics, which have complex processes, high temperatures, and are difficult to make fine arrays. Therefore, in order to achieve fingerprint recognition with micron-level recognition accuracy, only thin-film piezoelectric materials can be used. Thin-film piezoelectric materials greatly reduce piezoelectric performance, which in turn limits the transceiver performance of the ultrasonic transducer.

Compared with bulk piezoelectric ultrasonic transducers, Micromachined Ultrasonic Transducers (MUT) have simple processes and excellent transceiver performance, becoming a development trend. Micromachined ultrasonic transducers include Piezoelectric Micromachined Ultrasonic Transducers (PMUT) and Capacitive Micromachined Ultrasonic Transducers (CMUT). CMUT does not require the use of piezoelectric materials and can be made using conventional semiconductor manufacturing processes and materials, which is conducive to controlling production costs.

At present, the application of CMUT is basically based on low acoustic impedance working media such as air, water or human body. Since CMUT has good impedance matching characteristics with working media such as air, water or human body, it has high ultrasonic transmission efficiency. At present, there are few cases of applying CMUT to display panels.

### SUMMARY

The present disclosure provides a display panel and a manufacturing method therefor, and a display apparatus, which are used to improve the ultrasonic transmission efficiency of a CMUT in the display panel.

The first aspect of the present disclosure provides a display panel, including:
a display substrate including a support layer and a display layer arranged on the support layer;
an ultrasonic transducer arranged on a side of the support layer facing away from the display layer; wherein the ultrasonic transducer includes a vibration cavity and a vibration portion; the vibration portion is arranged between the vibration cavity and the support layer;
an acoustic matching layer arranged between the vibration portion and the support layer.

The display panel provided by the present disclosure further includes a bonding layer arranged on at least one side of the acoustic matching layer.

In the display panel provided by the present disclosure, the bonding layer is arranged between the acoustic matching layer and the support layer; and the acoustic matching layer is in direct contact with the vibration portion.

In the display panel provided by the present disclosure, the bonding layer includes a first bonding layer and a second bonding layer; the first bonding layer is arranged between the acoustic matching layer and the support layer; and the second bonding layer is arranged between the acoustic matching layer and the vibration portion.

In the display panel provided by the present disclosure, the acoustic matching layer is in direct contact with the support layer, and the acoustic matching layer is in direct contact with the vibration portion.

In the display panel provided by the present disclosure, a material of the acoustic matching layer is a viscous material.

The display panel provided by the present disclosure further includes a connection layer arranged between the support layer and the ultrasonic transducer;
the connection layer includes an edge connection structure arranged around an edge region of the ultrasonic transducer; one side of the edge connection structure is bonded to the support layer, and the other side of the edge connection structure is bonded to the ultrasonic transducer to form a closed space; an orthographic projection of the vibration cavity on the display substrate is located within an orthographic projection of the closed space on the display substrate; the acoustic matching layer is filled in the closed space.

The display panel further includes at least one support column arranged between the support layer and the ultrasonic transducer; the support column is arranged in a region surrounded by the edge connection structure and is spaced apart from the edge connection structure; an orthographic projection of the support column on the display substrate is located in a region outside the orthographic projection of the vibration cavity on the display substrate.

In the display panel provided by the present disclosure, the connection layer is arranged as a whole layer; the connection layer further includes an internal connection structure arranged in an region surrounded by the edge connection structure; the internal connection structure includes a first opening that penetrates the connection layer in a direction perpendicular to the display substrate; one first opening corresponds to one vibration cavity, and the orthographic projection of the vibration cavity on the display substrate is located within an orthographic projection of the first opening on the display substrate; the acoustic matching layer is arranged in the first opening.

In the display panel provided by the present disclosure, an acoustic impedance of the acoustic matching layer is between an acoustic impedance of the vibration portion and an acoustic impedance of the support layer.

In the display panel provided by the present disclosure, the acoustic matching layer is a single-layer structure, and the acoustic impedance of the acoustic matching layer satisfies:

$$Z = \sqrt{{Z}_{1} {Z}_{2}} ;$$

Z represents the acoustic impedance of the acoustic matching layer; Z1 represents the acoustic impedance of the vibration portion, and Z2 represents the acoustic impedance of the support layer.

In the display panel provided by the present disclosure, a shape of the vibration cavity is circular; and the acoustic impedance Z1 of the vibration portion satisfies:

$${Z}_{1} = \frac{p}{\overline{u}} = j {ωρ}_{2} h \frac{a {k}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) )}{\begin{matrix}{ak}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) ) - \\ 2 ( {k}_{1}^{2} + {k}_{2}^{2} ) {J}_{1} ( {k}_{1} a ) {I}_{1} ( {k}_{2} a )\end{matrix}} ,$$

$${k}_{1} = \sqrt{\frac{\sqrt{{d}^{2} + 4 {c}_{2} {ω}^{2}} + d}{2 {c}_{2}}} ; {k}_{2} = \sqrt{\frac{\sqrt{{d}^{2} + 4 {c}_{2} {ω}^{2}} - d}{2 {c}_{2}}} ;$$

$$c = \frac{( {E}_{1} + T ) {h}^{2}}{12 {ρ}_{2} ( 1 - {σ}^{2} )} ; d = \frac{T}{{ρ}_{2}} ;$$

p represents an average effective sound pressure on a surface of the vibration portion; ū represents a body velocity of the vibration portion; ω represents a vibration angular frequency of the vibration portion; ρ2 represents a density of the vibration portion; h represents a thickness of the vibration portion; a represents a radius of the vibration cavity; J0(x) represents a first type of zero-order Bessel function, x is an independent variable of the first type of zero-order Bessel function; J1(x) represents a first type of first-order Bessel function, x is an independent variable of the first type of first-order Bessel function; I0(x) represents a first type of zero-order modified Bessel function, x is the independent variable of the first type of zero-order modified Bessel function; I1(x) represents a first type of first-order modified Bessel function, x is an independent variable of the first type of first-order modified Bessel function; c2 represents a sound velocity of an ultrasonic wave propagating in the vibration portion; E1 represents a Young's modulus of the vibration portion; T represents an internal stress of the vibration portion; σ represents a Poisson's ratio of the vibration portion.

In the display panel provided by the present disclosure, a thickness of the acoustic matching layer is an odd multiple of a quarter wavelength of an ultrasonic wave emitted by the ultrasonic transducer.

In the display panel provided by the present disclosure, the acoustic matching layer is a multi-layer structure.

In the display panel provided by the present disclosure, the acoustic matching layer includes a first matching layer and a second matching layer stacked in sequence in a direction facing away from the ultrasonic transducer;
an acoustic impedance of the first matching layer satisfies:

$${Z}_{11} = \sqrt[3]{{Z}_{1}^{2} {Z}_{2}} ;$$

an acoustic impedance of the second matching layer satisfies:

$${Z}_{22} = \sqrt[3]{{Z}_{1} {Z}_{2}^{2}} ;$$

Z11 represents the acoustic impedance of the first matching layer; Z22 represents the acoustic impedance of the second matching layer; Z1 represents the acoustic impedance of the vibration portion; Z2 represents the acoustic impedance of the support layer.

In the display panel provided by the present disclosure, a thickness of each layer in the multi-layer structure of the acoustic matching layer is an odd multiple of a quarter wavelength of an ultrasonic wave emitted by the ultrasonic transducer.

In the display panel provided by the present disclosure, an orthographic projection of the ultrasonic transducer on the display substrate covers at least a partial region of the display substrate.

In the display panel provided by the present disclosure, the orthographic projection of the ultrasonic transducer on the display substrate covers the partial region of the display substrate; the display substrate further includes a super clean foam layer arranged on a side of the support layer facing the ultrasonic transducer; the super clean foam layer includes a second opening that penetrates the super clean foam layer in a direction perpendicular to the support layer, and the orthographic projection of the ultrasonic transducer on the display substrate is located in the second opening.

The second aspect of the present disclosure provides a display apparatus, including any one of aforementioned display panel.

The third aspect of the present disclosure provides method for manufacturing a display panel, including:
forming an acoustic matching layer on a side of a vibration portion of an ultrasonic transducer facing away from a vibration cavity;
attaching a display substrate to a side of the acoustic matching layer facing away from the ultrasonic transducer.

The beneficial effects of the present disclosure are as follows.

The present disclosure provides a display panel and a manufacturing method therefor, and a display apparatus. The display panel includes: a display substrate, an ultrasonic transducer, and an acoustic matching layer. The display substrate includes a support layer and a display layer located on the support layer. The ultrasonic transducer is located on the side of the support layer facing away from the display layer. The ultrasonic transducer includes a vibration cavity and a vibration portion. The vibration portion is located between the vibration cavity and the support layer. The acoustic matching layer is located between the vibration portion and the support layer. The ultrasonic transducer in the display panel provided by the present disclosure is a capacitive micromechanical ultrasonic transducer, which has a large bandwidth and strong penetration ability, which is conducive to improving the quality of the signal. Furthermore, the present disclosure sets an acoustic matching layer between the ultrasonic transducer and the display substrate to minimize the reflection and loss generated when the ultrasonic wave propagates at the interface between the ultrasonic transducer and the display substrate, thereby improving the transmission efficiency of the ultrasonic wave.

### BRIEF DESCRIPTION OF FIGURES

In order to more clearly illustrate the technical solutions of the embodiments of the present disclosure, the drawings required for use in the embodiments of the present disclosure will be briefly introduced below. Obviously, the drawings introduced below are only some embodiments of the present disclosure. For ordinary technicians in this field, other drawings can be obtained based on these drawings without paying creative work.

FIG. 1A is the first schematic diagram of a cross-sectional structure of a CMUT provided by an embodiment of the present disclosure;

FIG. 1B is the second schematic diagram of a cross-sectional structure of a CMUT provided by an embodiment of the present disclosure;

FIG. 2A is the first schematic diagram of a cross-sectional structure of a display panel provided by an embodiment of the present disclosure;

FIG. 2B is the second schematic diagram of a cross-sectional structure of a display panel provided by an embodiment of the present disclosure;

FIG. 3 is the third schematic diagram of a cross-sectional structure of a display panel provided by an embodiment of the present disclosure;

FIG. 4 is the fourth schematic diagram of a cross-sectional structure of a display panel provided by an embodiment of the present disclosure;

FIG. 5 is the fifth schematic diagram of a cross-sectional structure of a display panel provided by an embodiment of the present disclosure;

FIG. 6A is the sixth schematic diagram of a cross-sectional structure of a display panel provided by an embodiment of the present disclosure;

FIG. 6B is the first schematic diagram of a top view of a display panel provided by an embodiment of the present disclosure;

FIG. 7A is the seventh schematic diagram of a cross-sectional structure of a display panel provided by an embodiment of the present disclosure;

FIG. 7B is the second schematic diagram of a top view of a display panel provided by the embodiment of the present disclosure;

FIG. 8 is the eighth schematic diagram of a cross-sectional structure of a display panel provided by an embodiment of the present disclosure;

FIG. 9 is a flow chart of a method for manufacturing a display panel provided by an embodiment of the present disclosure.

### DETAILED DESCRIPTION

In order to make the above-mentioned purposes, features and advantages of the present disclosure more obvious and understandable, the present disclosure will be further described below in conjunction with the accompanying drawings and embodiments. However, the exemplary embodiments can be implemented in various forms and should not be construed as being limited to the embodiments described herein. On the contrary, these embodiments are provided to make the present disclosure more comprehensive and complete, and to fully convey the concepts of the exemplary embodiments to those skilled in the art. The same reference numerals in the figures represent the same or similar structures, and thus their repeated descriptions will be omitted. The words expressing position and direction described in the present disclosure are all explained using the accompanying drawings as examples, but changes may be made as needed, and the changes made are all included in the scope of protection of the present disclosure. The drawings of the present disclosure are only used to illustrate the relative position relationship and do not represent the true proportion.

Fingerprint recognition technology is widely used in mobile terminals such as mobile phones and tablets, as well as in security protection fields such as access control systems and safes. At present, the main ways to realize fingerprint collection in fingerprint recognition technology are optical, capacitive and ultrasonic imaging. Among them, the fingerprint collection of ultrasonic fingerprint recognition technology has 3D characteristics, and the user's finger does not need to touch the fingerprint collection device, which can improve the security of recognition and the user's experience.

Existing ultrasonic fingerprint recognition technology usually uses bulk piezoelectric ultrasonic transducers. Traditional bulk piezoelectric materials use piezoelectric ceramics, which have complex processes, high temperatures, and are difficult to make fine arrays. Therefore, in order to achieve fingerprint recognition with micron-level recognition accuracy, only thin-film piezoelectric materials can be used. Thin-film piezoelectric materials greatly reduce piezoelectric performance, which in turn limits the transceiver performance of the ultrasonic transducer.

Compared with bulk piezoelectric ultrasonic transducers, Micromachined Ultrasonic Transducers (MUT) have simple processes and excellent transceiver performance, becoming a development trend. Micromachined Ultrasonic Transducers include Piezoelectric Micromachined Ultrasonic Transducers (PMUT) and capacitive Micromachined Ultrasonic Transducers (CMUT). CMUT does not require the use of piezoelectric materials and can be made using conventional semiconductor manufacturing processes and materials, which is conducive to controlling production costs.

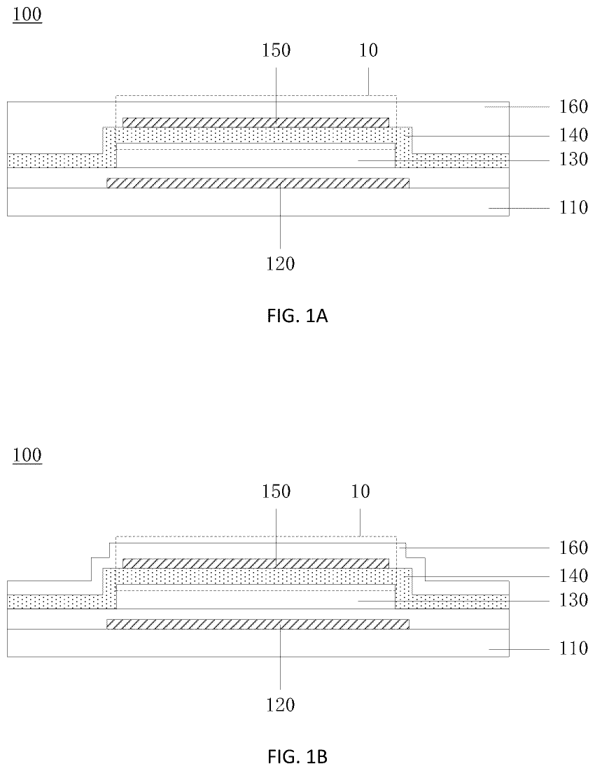

FIG. 1A is the first schematic diagram of a cross-sectional structure of a CMUT according to an embodiment of the present disclosure. FIG. 1B is the second schematic diagram of a cross-sectional structure of a CMUT according to an embodiment of the present disclosure.

In the embodiment of the present disclosure, as shown in FIG. 1A and FIG. 1B, the CMUT includes a base substrate 110, a first electrode 120, a diaphragm layer 140, a second electrode 150, an insulating protection layer 160, and a vibration cavity 130 located between the diaphragm layer 140 and the first electrode 120, which are stacked in sequence. Among them, one vibration cavity 130 corresponds to one first electrode 120 and one second electrode 150, and one vibration cavity 130 is located between the corresponding first electrode 120 and the corresponding second electrode 150, forming a transducer unit. An ultrasonic transducer may include at least one transducer unit, which is not limited here. In specific implementation, as shown in FIG. 1A and FIG. 1B, the orthographic projection of the second electrode 150 on the base substrate 110 can be arranged to be located within the orthographic projection of the corresponding vibration cavity 130 on the base substrate 110, and the orthographic projection of the vibration cavity 130 on the base substrate 110 is located within the orthographic projection of the corresponding first electrode 120 on the base substrate 110, so as to improve the sensitivity of the ultrasonic transducer unit.

In the ultrasonic emission stage, a DC signal and an AC signal are simultaneously applied to the first electrode 120 and the second electrode 150, so that the diaphragm layer 140 located between the first electrode 120 and the second electrode 150 vibrates with the change of the AC electric field, and drives the second electrode 150 and the insulating protection layer 160 located on the side of the diaphragm layer 140 facing away from the vibration cavity 130 to vibrate together to emit ultrasonic waves. In the ultrasonic reception stage, only a DC signal is applied between the first electrode 120 and the second electrode 150 to keep the diaphragm layer 140 balanced, and the diaphragm layer 140, the second electrode 150 and the insulating protection layer 160 generate vibration displacement under the action of ultrasonic waves, thereby changing the capacitance between the first electrode 120 and the second electrode 150 to receive ultrasonic waves.

When the ultrasonic transducer is working, it mainly utilizes the vibration of multiple film layers located on the side of the vibration cavity 130 facing away from the first electrode 120 and in the overlapping region with the vibration cavity 130 to transmit and absorb ultrasonic waves. In the subsequent content of this disclosure, this part of the film layers is referred to as the vibration portion 10. In specific implementation, as shown in FIG. 1A and FIG. 1B, the vibration portion 10 includes a part of the diaphragm layer 140 located on the side of the vibration cavity 130 facing away from the first electrode 120, the second electrode 150 and a part of the insulating protection layer 160, and the orthographic projection of the vibration portion 10 on the base substrate 110 completely overlaps with the orthographic projection of the vibration cavity 130 on the base substrate 110.

The base substrate 110 is located at the bottom of the CMUT and is used to carry and support the film layers such as the first electrode 12 located thereon. In specific implementation, the base substrate 110 can be made of insulating materials such as glass and resin. In some embodiments, a driving circuit can also be made between the base substrate 110 and the first electrode 120 to realize the ultrasonic transmission and reception control and signal collection. The driving circuit includes at least one thin film transistor (TFT), and the driving circuit can be made using a display semiconductor process in specific implementation, which is not limited here.

The diaphragm layer 140 may be a single-layer structure or a multi-layer structure, which is not limited here. In a specific implementation, the material of the diaphragm layer 140 may be at least one of low-temperature polysilicon, silicon nitride (SiN) or silicon oxide (SiO₂), which is not limited here.

The insulating protection layer 160 may be a single-layer structure or a multi-layer structure, which is not limited here. In specific implementation, the material of the insulating protection layer 160 may be at least one of low-temperature polysilicon, silicon nitride (SiN) or silicon oxide (SiO₂), which is not limited here. In some embodiments, the insulating protection layer 160 may be made of the same material as the diaphragm layer 140, which is not limited here. In some embodiments, as shown in FIG. 1A, during the manufacturing process, a thick insulating protection layer may be formed on the side of the second electrode 150 facing away from the base substrate 110 by a thin film deposition process, and then the insulating protection layer may be thinned by a process such as polishing to reduce the thickness of the vibration portion 10 and reduce the collapse voltage, and a relatively flat surface may be formed on the side of the insulating protection layer facing away from the base substrate 110 by a process such as polishing to improve the transmission efficiency and directivity of the ultrasonic wave. In some embodiments, as shown in FIG. 1B, during the manufacturing process, a thin insulating protection layer 160 may be formed directly on the side of the second electrode 150 facing away from the substrate 110 by a thin film deposition process, thereby reducing the process steps. As shown in FIG. 1B, the thin insulating protection layer 160 forms steps at the corners of the surface of the ultrasonic transducer.

The ultrasonic transducer provided in the embodiment of the present disclosure may also include other structures not mentioned. The structures not mentioned in the ultrasonic transducer provided in the embodiment of the present disclosure may be manufactured by referring to the relevant manufacturing methods in the related art, and will not be described in detail here.

At present, the application of CMUT is basically based on working media with low acoustic impedance such as air, water or human body. Since CMUT has good impedance matching characteristics with working media such as air, water or human body, it has high ultrasonic transmission efficiency. At present, there are few cases of applying CMUT to display panels. The inventors of the present disclosure found in the process of applying the CMUT provided by the embodiment of the present disclosure to the production of display panels that due to the large difference between the acoustic impedance of the CMUT and the acoustic impedance of the display substrate, when the CMUT is directly bonded to the display substrate, the ultrasonic wave will produce a large energy loss when propagating at the bonding interface between the CMUT and the display substrate, and the transmission efficiency of the ultrasonic wave is low.

In view of this, the present disclosure provides a display panel that can improve the transmission efficiency of ultrasonic waves between a CMUT and a display substrate.

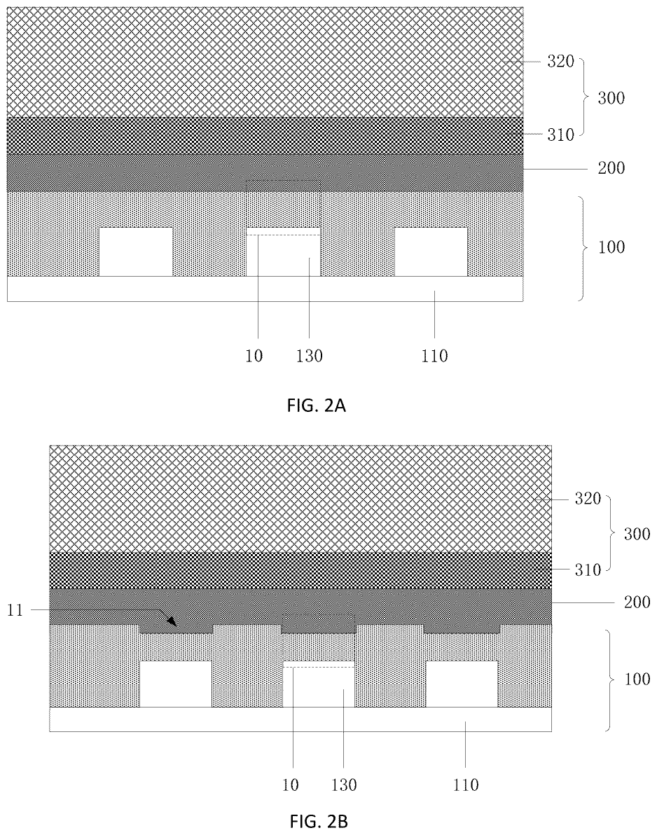

FIG. 2A is the first the schematic diagram of the cross-sectional structure of the display panel provided by the embodiment of the present disclosure. FIG. 2B is the second schematic diagram of the cross-sectional structure of the display panel provided by the embodiment of the present disclosure.

In the embodiment of the present disclosure, as shown in FIG. 2A and FIG. 2B, the display panel includes: an ultrasonic transducer 100, an acoustic matching layer 200 and a display substrate 300.

The display substrate 300 is used for image display. The shape and size of the display substrate 300 are adapted to the shape and size of the display panel, and its shape can be a conventional shape such as a square or a rectangle, or a special shape such as a circle, which is not limited here. As shown in FIG. 2A and FIG. 2B, the display substrate 300 includes a support layer (U-film) 310 and a display layer 320 located on the support layer 310. The support layer 310 is used to support and carry the display layer 320. In a specific implementation, the display substrate 300 is bonded to the acoustic matching layer 200 through the support layer 310. The display layer 320 includes a plurality of pixel units, each of which is used to emit light for image display.

In the disclosed embodiment, the display substrate 300 may be an organic light emitting diode (OLED) display substrate. The support layer 310 may be a substrate of an OLED display substrate, and the support layer 310 may be made of a flexible material to form a flexible OLED display substrate, or the support layer 310 may be made of a rigid material to form a rigid OLED display substrate. In a specific implementation, the support layer 310 may be made of glass, resin or other materials, which are not limited here. The display layer 320 may include a driving circuit layer and a light emitting function layer located on the driving circuit layer. The driving circuit layer includes a plurality of pixel circuits, the light emitting function layer includes a plurality of OLEDs. One pixel circuit is electrically connected to one OLED to form one pixel unit, and the pixel circuit is used to drive the OLED connected thereto to emit light. In a specific implementation, the pixel circuit may include at least one thin film transistor, and the OLED may include a film layer structure such as a hole injection layer, a hole transport layer, a light emitting layer, an electron transport layer and an electron injection layer, which are not limited here. The side of the display layer 320 facing the support layer 310 can be bonded to the support layer 310 through a first adhesive layer, and the side of the display layer 320 facing away from the support layer 310 can be connected to the polarizer through a second adhesive layer. The first adhesive layer and the second adhesive layer can both use pressure sensitive adhesive (PSA), which is not limited here. The polarizer can be a circular polarizer, which is used to absorb ambient light incident from the outside to the inside of the OLED display substrate to prevent the metal electrodes and signal lines in the OLED display substrate from reflecting ambient light and affecting the display effect. The side of the polarizer facing away from the display layer 320 can be bonded to the cover glass (CG) through a third adhesive layer, and the cover glass can be used to protect the OLED display substrate. The third adhesive layer can use optically clear adhesive (OCA), which is not limited here.

In some embodiments, the display substrate 300 may also be other types of display substrates, such as a liquid crystal display (LCD) substrate, a micro light emitting diode (Micro LED) display substrate, etc., which are not limited here. For example, when the display substrate 300 is a liquid crystal display substrate, the support layer 310 may be an array substrate of the liquid crystal display substrate, which is not limited here.

The ultrasonic transducer 100 is located on the side of the support layer 310 facing away from the display layer 320. In a specific implementation, the ultrasonic transducer 100 may be a Capacitive Micromachined Ultrasonic Transducer (CMUT). The ultrasonic transducer 100 includes a vibration cavity 130 and a vibration portion 10. The vibration portion 10 is located between the vibration cavity 130 and the support layer 310. The specific structure of the ultrasonic transducer 100 can be referred to the relevant description of FIG. 1A and FIG. 1B, which will not be repeated here.

The acoustic matching layer 200 is located between the vibration portion 10 and the support layer 310. The acoustic matching layer 200 can reduce reflection and loss as much as possible during the transmission of ultrasonic waves between the ultrasonic transducer 100 and the support layer 310, thereby improving the transmission efficiency of ultrasonic waves.

In the embodiment of the present disclosure, CMUT is applied to the production of display panels to realize fingerprint recognition, gesture recognition, touch operation and other functions of the display panel. CMUT has a large bandwidth and strong penetration ability, which is conducive to improving the quality of the signal. Furthermore, in the embodiment of the present disclosure, an acoustic matching layer 200 is provided between the ultrasonic transducer 100 and the display substrate 300 to minimize the reflection and loss of ultrasonic waves when propagating between the ultrasonic transducer 100 and the display substrate 300, thereby improving the transmission efficiency of ultrasonic waves.

In some embodiments, as shown in FIG. 2A, the surface of the ultrasonic transducer 100 facing away from the base substrate 110 is a relatively flat surface.

In some embodiments, as shown in FIG. 2B, a plurality of grooves 11 are provided on the surface of the ultrasonic transducer 100 on the side facing away from the base substrate 110, and a part of the acoustic matching layer 200 is filled in the grooves 11. One groove 11 corresponds to one vibration cavity 130, and the orthographic projection of the vibration cavity 130 on the base substrate 110 is located within the orthographic projection of the corresponding groove 11 on the base substrate 110. By providing the grooves 11 on the surface of the ultrasonic transducer 100 on the side facing away from the base substrate 110, the thickness of the vibration portion 10 can be reduced, thereby improving the vibration performance of the vibration portion 10, and reducing the thickness of the vibration portion 10 is conducive to reducing the driving voltage. In specific implementation, after manufacturing the insulating protection layer 160 of the CMUT, the insulating protection layer 160 can be patterned and etched to form the grooves 11, which is not limited here.

In the embodiment of the present disclosure, the acoustic impedance of the acoustic matching layer 200 is between the acoustic impedance of the vibration portion 10 and the acoustic impedance of the support layer 310. In specific implementation, the acoustic matching layer 200 can adopt a single-layer structure or a multi-layer structure, which is not limited here.

In some embodiments, the acoustic matching layer 200 may be a single-layer structure. The acoustic impedance of the acoustic matching layer 200 satisfies the following conditions:

$$Z = \sqrt{{Z}_{1} {Z}_{2}} .$$

Here, Z represents the acoustic impedance of the acoustic matching layer 200. Z1 represents the acoustic impedance of the vibration portion 10, and Z2 represents the acoustic impedance of the support layer 310.

In a specific implementation, the display substrate 300 contacts the acoustic matching layer 200 through the support layer 310. The support layer 310 can be regarded as a single-layer structure located at the bottom of the display substrate 300 and in contact with the acoustic matching layer 200. The acoustic impedance Z2 of the support layer 310 can be calculated by the following formula:

$${Z}_{2} = {ρ}_{1} {c}_{1} ;$$

ρ₁ represents the density of the support layer 310, and c₁ represents the sound velocity of the ultrasonic wave propagating in the support layer 310.

The vibration portion 10 is a laminated structure formed by stacking multiple film layers and arranged on the vibration cavity 130. Since the vibration portion 10 transmits or receives ultrasonic waves by vibrating multiple laminated film layers together, the acoustic impedance of the vibration portion 10 cannot be simply calculated by the parameters of a single film layer. Taking the circular vibration cavity as an example, the acoustic impedance Z₁ of the vibration portion 10 can be calculated by the following formula:

$${Z}_{1} = \frac{p}{\overline{u}} = j {ωρ}_{2} h \frac{a {k}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) )}{\begin{matrix}{ak}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) ) - \\ 2 ( {k}_{1}^{2} + {k}_{2}^{2} ) {J}_{1} ( {k}_{1} a ) {I}_{1} ( {k}_{2} a )\end{matrix}} ;$$

$${k}_{1} = \sqrt{\frac{\sqrt{{d}^{2} + 4 {c}_{2} {ω}^{2}} + d}{2 {c}_{2}}} ; {k}_{2} = \sqrt{\frac{\sqrt{{d}^{2} + 4 {c}_{2} {ω}^{2}} - d}{2 {c}_{2}}} ;$$

$$c = \frac{( {E}_{1} + T ) {h}^{2}}{12 {ρ}_{2} ( 1 - {σ}^{2} )} ; d = \frac{T}{{ρ}_{2}} ;$$

p represents the average effective sound pressure on the surface of the vibration portion 10; ū represents the body velocity of the vibration portion 10; ω represents the vibration angular frequency of the vibration portion; ρ₂ represents the density of the vibration portion 10, specifically, represents the average density of multiple film layers forming the vibration portion 10; h represents the thickness of the vibration portion 10. When the thickness of the vibration portion 10 is uneven, h represents the average thickness of the vibration portion 10; a represents the radius of the circular vibration cavity; J₀(x) represents the first type of zero-order Bessel function, x is the independent variable of the function; J₁ (x) represents the first type of first-order Bessel function, x is the independent variable of the function; I₀(x) represents the first type of zero-order modified Bessel function, x is the independent variable of the function; I₁(x) represents the first type of first-order modified Bessel function, x is the independent variable of the function; c₂ represents the speed of sound propagating in the vibration portion 10; E₁ represents the Young's modulus of the vibration portion 10; T represents the internal stress of the vibration portion 10; σ represents the Poisson's ratio of the vibration portion 10.

After determining the acoustic impedance Z₂ of the support layer 310 and the acoustic impedance Z₁ of the vibration portion, the acoustic impedance Z of the acoustic matching layer 200 can be calculated according to the formula Z=\sqrt{Z₁Z₂}, so as to select a material with the corresponding acoustic impedance to make the acoustic matching layer 200. Since the acoustic matching layer 200 is a single-layer structure, its acoustic impedance Z satisfies: Z=ρc, where ρ represents the density of the acoustic matching layer 200,

$$c = \sqrt{\frac{E ( 1 - ϑ )}{ρ ( 1 + ϑ ) ( 1 - 2 ϑ )}} ,$$

E represents the Young's modulus of the acoustic matching layer 200, and θ represents the Poisson's ratio of the acoustic matching layer 200. Then, the Young's modulus E, density p and Poisson's ratio θ of the acoustic matching layer 200 can be determined according to the above relationship, and a suitable material can be selected to make the acoustic matching layer 200. When the support layer 310 is made of conventional materials used in display semiconductor processes (such as polyethylene terephthalate (PET)), the Young's modulus E of the acoustic matching layer 200 ranges from 5E⁶ Pa to 100E⁶ Pa, the density ρ ranges from 1000 kg/m³ to 3000 kg/m³, and the Poisson's ratio θ ranges from 0.25 to 0.47, which can obtain better ultrasonic transmission efficiency.

The above content takes the vibration cavity 130 as a circular vibration cavity to illustrate the process of determining the acoustic impedance of the acoustic matching layer 200. In specific implementation, the vibration cavity 130 can also be of other shapes. It is only necessary to determine the acoustic impedance of the support layer 310 and the acoustic impedance of the vibration portion 10, and then the acoustic impedance of the acoustic matching layer 200 can be determined according to the formula Z=\sqrt{Z₁Z₂}, and then the Young's modulus, density, Poisson's ratio and other parameters of the acoustic matching layer 200 can be determined, which will not be repeated here.

In a specific implementation, when the thickness of the acoustic matching layer 200 is an odd multiple of a quarter wavelength of the ultrasonic wave emitted by the ultrasonic transducer 100, the reflection and absorption of the ultrasonic wave by the acoustic matching layer 200 can be effectively reduced, and the transmittance of the ultrasonic wave in the acoustic matching layer 200 can be improved. In a specific implementation, the thickness h1 of the acoustic matching layer 200 satisfies the following conditions:

$${h}_{1} = ( 2 n + 1 ) {h}^{′} ,$$

$${h}^{′} = \frac{1}{4} λ = \frac{1}{4} \frac{c}{f} \approx \frac{1}{4 f} \sqrt{\frac{E}{ρ}} ,$$

λ represents the wavelength of the ultrasonic wave emitted by the ultrasonic transducer 100 when propagating in the acoustic matching layer 200; f represents the vibration frequency of the ultrasonic wave emitted by the ultrasonic transducer 100 when propagating in the acoustic matching layer 200. Thus, the thickness of the acoustic matching layer 200 can be calculated according to the above formula and parameters such as Young's modulus E and density ρ of the acoustic matching layer 200. n can be selected according to actual needs. In order to reduce propagation loss and improve processing accuracy, the value of n can be 0 or 1 to obtain a greater ultrasonic transmission efficiency.

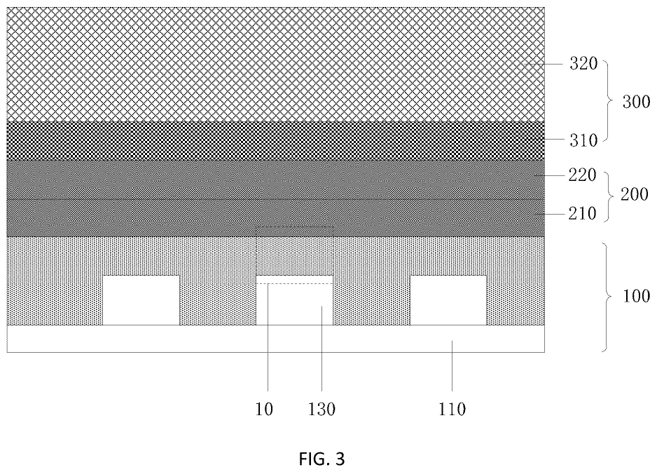

FIG. 3 is the third schematic diagram of the cross-sectional structure of the display panel provided by the embodiment of the present disclosure.

In some embodiments, the acoustic matching layer 200 may be a multi-layer structure. The multi-layer structure of the acoustic matching layer 200 is conducive to further improving the transmission efficiency of ultrasonic waves, and when the multi-layer structure of the acoustic matching layer 200 is manufactured, due to the superposition of the multi-layer structure, the performance requirements for a single film layer can be reduced, the material selection range of a single film layer can be expanded, and the difficulty of material selection can be reduced. In specific implementation, the multiple film layers of the acoustic matching layer 200 can be bonded by adhesive, or can be directly laminated in sequence using a coating process, thereby reducing the use of adhesive, reducing the propagation interface, and further improving the transmission efficiency.

For example, as shown in FIG. 3, the acoustic matching layer 200 may include a first matching layer 210 and a second matching layer 220 stacked in sequence in a direction facing away from the ultrasonic transducer 100. The acoustic impedance of the first matching layer 210 satisfies the following conditions:

$${Z}_{11} = \sqrt[3]{{Z}_{1}^{2} {Z}_{2}} ;$$

the acoustic impedance of the second matching layer 220 satisfies:

$${Z}_{22} = \sqrt[3]{{Z}_{1} {Z}_{2}^{2}} ;$$

Z₁₁ represents the acoustic impedance of the first matching layer 210; Z₂₂ represents the acoustic impedance of the second matching layer 220; Z₁ represents the acoustic impedance of the vibration portion 10; and Z₂ represents the acoustic impedance of the support layer 310. The ultrasonic wave transmittance of the double-layered acoustic matching layer 200 is about 2.75 times that of the single-layered acoustic matching layer, which can significantly improve the transmission efficiency of ultrasonic waves.

When the acoustic matching layer 200 is a multi-layer structure, the thickness of each layer in the multi-layer structure of the acoustic matching layer 200 can be set to an odd multiple of a quarter wavelength of the ultrasonic wave emitted by the ultrasonic transducer 100 to improve the transmittance of the ultrasonic wave. In specific implementation, the thickness of each film layer of the acoustic matching layer 200 can be determined by referring to the thickness determination process of the aforementioned single-layer acoustic matching layer, which will not be described in detail here.

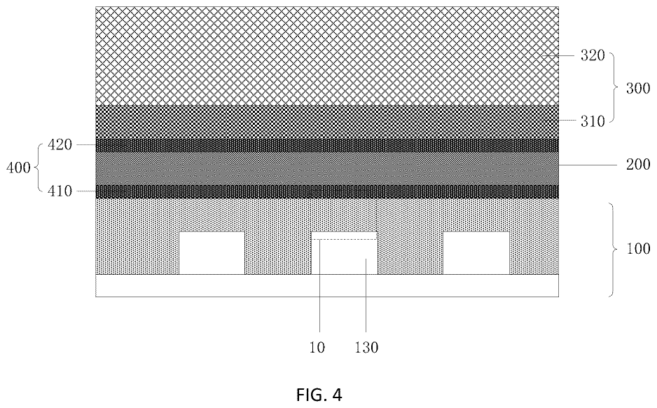

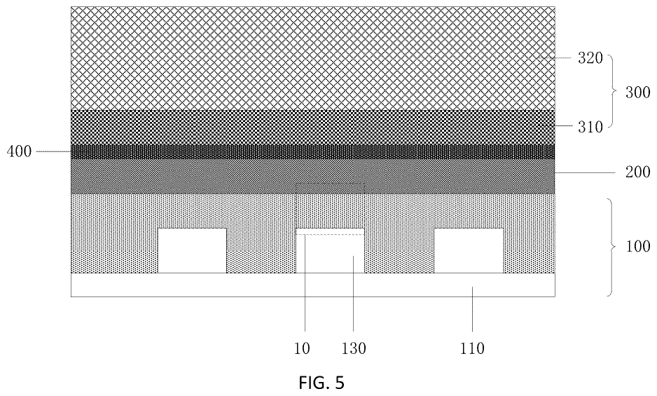

FIG. 4 is the fourth schematic diagram of the cross-sectional structure of a display panel provided by an embodiment of the present disclosure. FIG. 5 is the fifth schematic diagram of the cross-sectional structure of a display panel provided by an embodiment of the present disclosure.

In some embodiments, as shown in FIG. 4 and FIG. 5, the display panel further includes a bonding layer 400. The bonding layer 400 is located on at least one side of the acoustic matching layer 200, and is used to bond and fix the acoustic matching layer 200 to the support layer 310 and/or the vibration portion 10. The bonding layer 400 can be made of a viscous material such as a pressure-sensitive adhesive and an optical adhesive. In a specific implementation, the thickness of the bonding layer 400 can be set to 3 μm to 10 μm, and the thickness of the bonding layer 400 can be reduced as much as possible to avoid affecting the transmission efficiency of ultrasonic waves. The acoustic matching layer 200 is bonded and fixed to the support layer 310 and/or the vibration portion 10 through the bonding layer 400, so that the acoustic matching layer 200 can be made of a non-viscous resin material such as polydimethylsiloxane (PDMS), which is not limited here.

In some embodiments, as shown in FIG. 4, the bonding layer 400 includes a first bonding layer 410 and a second bonding layer 420. The second bonding layer 420 is located between the acoustic matching layer 200 and the support layer 310, and is used for bonding between the acoustic matching layer 200 and the support layer 310. The first bonding layer 410 is located between the acoustic matching layer 200 and the vibration portion 10, and is used for bonding between the acoustic matching layer 200 and the ultrasonic transducer 100. The acoustic matching layer 200 does not need to be made of a viscous material or a material that can be directly plated, thereby expanding the optional range of the acoustic matching layer 200.

In some embodiments, as shown in FIG. 5, the bonding layer 400 is located between the acoustic matching layer 200 and the support layer 310. The acoustic matching layer 200 is in direct contact with the vibration portion 10. In a specific implementation, the acoustic matching layer 200 can be formed directly on the surface of the ultrasonic transducer 100 by a coating process, such as chemical vapor deposition, coating, etc., thereby avoiding the need to provide a bonding layer 400 between the acoustic matching layer 200 and the vibration portion 10, reducing the interface of ultrasonic wave propagation, and improving the transmission efficiency. On the side of the acoustic matching layer 200 facing away from the ultrasonic transducer 100, the acoustic matching layer 200 and the support layer 310 can be bonded by the bonding layer 400, which is beneficial to increase the optional range of materials for the acoustic matching layer 200.

In some embodiments, the acoustic matching layer 200 is in direct contact with the support layer 310, and the acoustic matching layer 200 is in direct contact with the vibration portion 10. The acoustic matching layer 200 is directly bonded to the support layer 310 and the vibration portion 10 respectively, without providing a film layer such as a bonding layer for bonding, which can reduce the interface of ultrasonic wave propagation, reduce the energy loss caused by interface reflection, and improve the transmission efficiency.

In some embodiments, the acoustic matching layer 200 can be made of viscous material, so that the acoustic matching layer 200 can be directly bonded to the ultrasonic transducer 100 and the display substrate 300. In specific implementations, the acoustic matching layer 200 can be made of viscous materials such as pressure-sensitive adhesive and optical adhesive that meet the acoustic impedance conditions, which is not limited here.

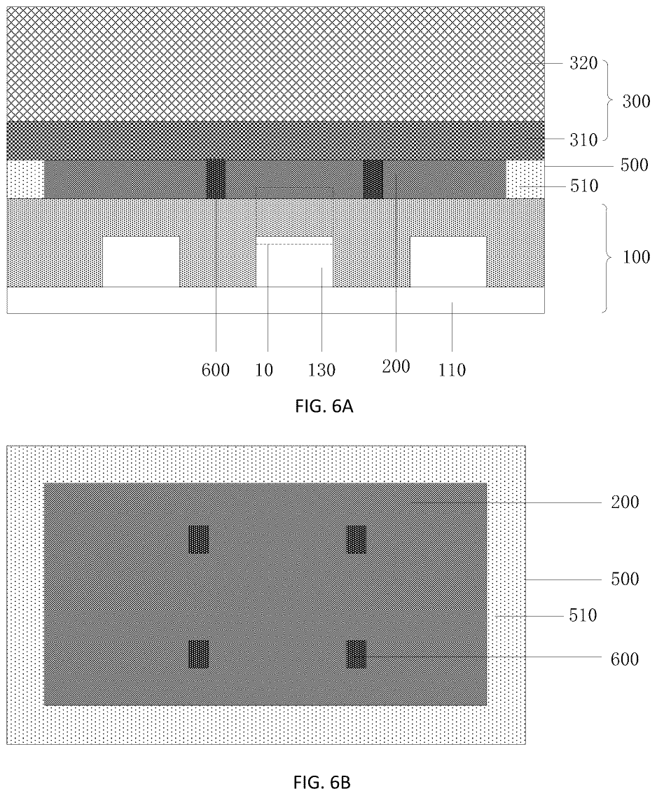

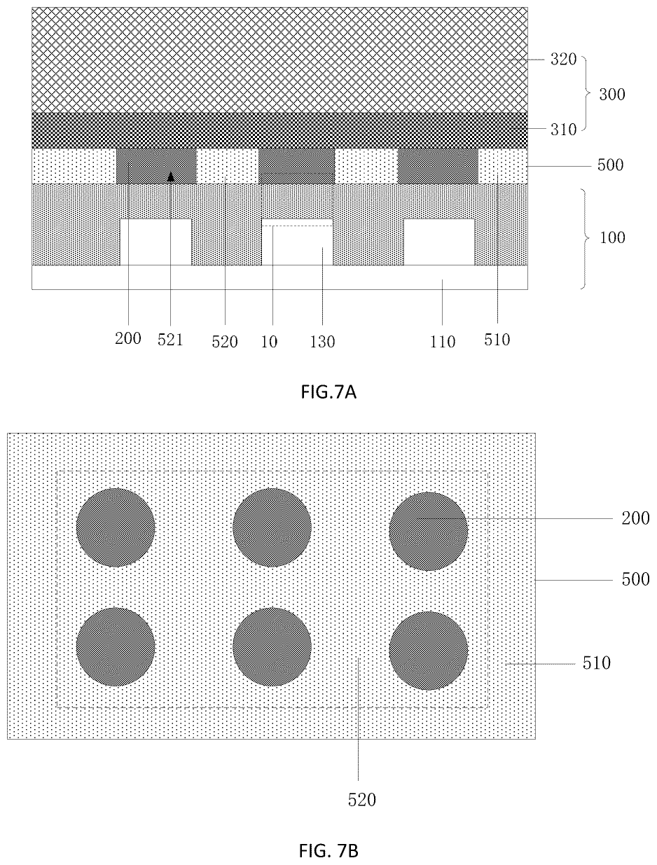

FIG. 6A is the sixth schematic diagram of the cross-sectional structure of the display panel provided by the embodiment of the present disclosure. FIG. 6B is the first schematic diagram of the top view structure of the display panel provided by the embodiment of the present disclosure. FIG. 7A is the seventh schematic diagram of the cross-sectional structure of the display panel provided by the embodiment of the present disclosure. FIG. 7B is the second schematic diagram of the top view structure of the display panel provided by the embodiment of the present disclosure.

In some embodiments, as shown in FIG. 6A to FIG. 7B, the display panel further includes a connection layer 500. The connection layer 500 is located between the support layer 310 and the ultrasonic transducer 100, and is used to bond the support layer 310 to the ultrasonic transducer 100. The connection layer 500 can be made of a viscous material, or the connection layer 500 can be made of a double-sided viscous material, which is not limited here.

In a specific implementation, as shown in FIG. 6A to FIG. 7B, the connection layer 500 includes an edge connection structure 510 arranged around the edge region of the ultrasonic transducer 100. One side of the edge connection structure 510 is bonded to the support layer 310, and the other side is bonded to the ultrasonic transducer 100, thereby forming a closed space with the display substrate 300 and the ultrasonic transducer 100. The orthographic projection of the vibration cavity 130 on the display substrate 300 (or the base substrate 110) is located within the orthographic projection of the closed space on the display substrate 300 (or the base substrate 110). The acoustic matching layer 200 is filled in the closed space. In a specific implementation, the display substrate 300 and the ultrasonic transducer 100 are bonded by the edge connection structure 510, so that the acoustic matching layer 200 does not need to be made of a viscous material or a material that can be directly plated. The display substrate 300, the ultrasonic transducer 100 and the edge connection structure 510 form a closed space for accommodating the acoustic matching layer 200, so that the material of the acoustic matching layer 200 is not limited to solid material, and liquid material can also be used to fill the closed space, further expanding the selection range of the material of the acoustic matching layer 200.

In some embodiments, as shown in FIG. 6A and FIG. 6B, where FIG. 6B is a schematic diagram of a top view of the structure of FIG. 6A, the display panel further includes at least one support column 600. The support column 600 is located between the support layer 310 and the ultrasonic transducer 100 to support and maintain the distance between the support layer 310 and the ultrasonic transducer 100. The support column 600 is located within the region surrounded by the edge connection structure 510 and is spaced apart from the edge connection structure 510. In a specific implementation, the orthographic projection of the support column 600 on the display substrate 300 (or the base substrate 110) is located in a region outside the orthographic projection of the vibration cavity 130 on the display substrate 300 (or the base substrate 110), and the support column 600 does not overlap with the vibration portion 10, which can avoid the support column 600 from affecting the transmission efficiency of the ultrasonic wave and improve the transmission effect. The acoustic matching layer 200 can be made of a flexible solid material or a liquid material by a coating process or a direct injection filling method, which is not limited here.

In some embodiments, as shown in FIG. 7A and FIG. 7B where FIG. 7B is a schematic diagram of a top view of the structure of FIG. 7A, the connection layer 500 is provided as a whole layer. The connection layer 500 further includes an internal connection structure 520, which is located in the region surrounded by the edge connection structure 510. The internal connection structure 520 can play a role in supporting and maintaining the distance between the support layer 310 and the ultrasonic transducer 100. The internal connection structure 520 is provided with a first opening 521 that penetrates the connection layer 500 in a direction perpendicular to the display substrate 300 (or the base substrate 110). One first opening 521 corresponds to one vibration cavity 130, and the orthographic projection of the vibration cavity 130 on the display substrate 300 (or the base substrate 110) is located within the orthographic projection of the corresponding first opening 521 on the display substrate 300 (or the base substrate 110), thereby avoiding the overlap of the internal connection structure 520 and the vibration cavity 130 to affect the transmission efficiency of the ultrasonic wave. The acoustic matching layer 200 is located in the first opening 521. In specific implementation, the entire connection layer 500 may be subjected to a hole-opening process to form the first opening 521, and then the material of the acoustic matching layer 200 is filled into the first opening 521 to form the acoustic matching layer 200, which is not limited here.

In some embodiments, as shown in FIG. 7A and FIG. 7B, the ultrasonic transducer 100 may include a plurality of vibration cavities 130. The plurality of vibration cavities 130 correspond to the plurality of first openings 521, respectively, and the acoustic matching layer 200 is filled in the plurality of first openings 521. The portions of the acoustic matching layer 200 filled in each first opening 521 are spaced by the internal connection structure 520, thereby reducing the lateral propagation of ultrasonic waves and reducing ultrasonic crosstalk between adjacent transducer units.

In a specific implementation, when the ultrasonic wave propagates in the acoustic matching layer 200, and the ultrasonic wave propagates to the interface formed by the acoustic matching layer 200 and the internal connection structure 520, a part of the ultrasonic wave is reflected back to the acoustic matching layer 200 for propagation, thereby reducing the interference between the ultrasonic waves propagating in the acoustic matching layer 200 in the adjacent first openings 521. For the interface formed by the acoustic matching layer 200 and the internal connection structure 520, the reflectivity r of the ultrasonic wave satisfies the following conditions:

$$Γ = \vert \frac{Z - {Z}_{3}}{Z + {Z}_{3}} \vert ;$$

Z represents the acoustic impedance of the acoustic matching layer 200; Z₃ represents the acoustic impedance of the internal connection structure 520. When the magnitudes of Z and Z₃ differ greatly, the reflectivity r of the ultrasonic wave at the interface formed by the acoustic matching layer 200 and the internal connection structure 520 can approach 1. Therefore, in a specific implementation, a material with a large difference in acoustic impedance from the acoustic matching layer 200 can be selected as much as possible to make the connection layer 500, thereby increasing the reflectivity r of the ultrasonic wave at the interface formed by the acoustic matching layer 200 and the internal connection structure 520, reducing crosstalk, and improving the transmission efficiency in the longitudinal direction (the direction perpendicular to the display substrate 300 or the base substrate 110).

In some embodiments, as shown in FIG. 2A and FIG. 2B, the ultrasonic transducer 100 may be disposed entirely on the side of the support layer 310 facing away from the display layer 320, and the orthographic projection of the ultrasonic transducer 100 on the display substrate 300 covers the entire surface region of the display substrate 300. The ultrasonic transducer 100 may emit ultrasonic waves on the entire surface region of the display substrate 300, thereby realizing functions such as fingerprint recognition, gesture recognition, and touch operation on the entire surface region of the display panel.

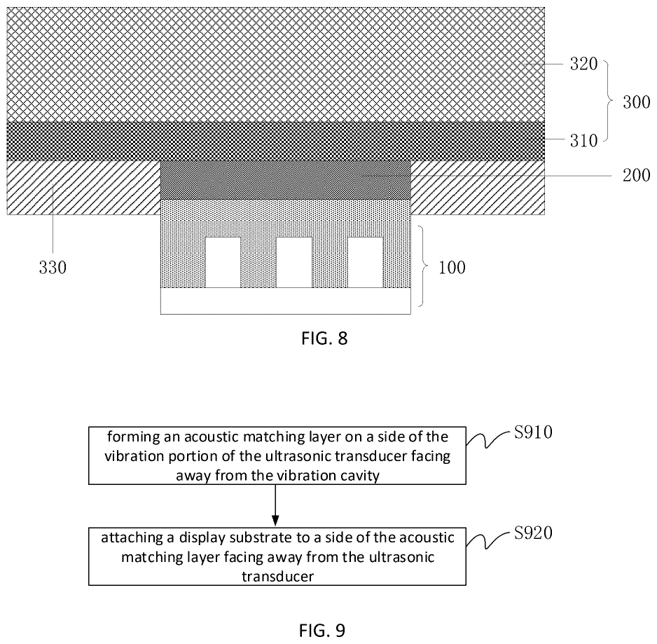

FIG. 8 is the eighth schematic diagram of the cross-sectional structure of the display panel provided by the embodiment of the present disclosure.

In some embodiments, as shown in FIG. 8, the ultrasonic transducer 100 is disposed on a side of the support layer 310 facing away from the display layer 320, and the orthographic projection of the ultrasonic transducer 100 on the display substrate 300 covers a partial region of the display substrate 300. The ultrasonic transducer 100 can emit ultrasonic waves in a partial region of the display substrate 300, so that functions such as fingerprint recognition, gesture recognition, and touch operation can be realized in a specific region of the display panel.

In a specific implementation, as shown in FIG. 8, the display substrate 300 further includes a super clean foam layer (SCF) 330. The super clean foam layer 330 is located on the side of the support layer 310 facing the ultrasonic transducer 100. The super clean film layer 330 may be a single-layer foam structure, or a multi-layer structure including a foam layer, a metal layer, and a plurality of film layers, for heat dissipation, buffering, and the like. The super clean foam layer 330 is provided with a second opening penetrating the super clean foam layer 330 in a direction perpendicular to the support layer 310. The second opening exposes the support layer 310, and the orthographic projection of the ultrasonic transducer 100 on the display substrate 300 is located in the second opening, and the ultrasonic transducer 100 is bonded to the support layer 310 exposed by the second opening through the second opening.

The display panel provided in the embodiment of the present disclosure may also include other structures not mentioned. The structures not mentioned in the display panel provided in the embodiment of the present disclosure may refer to the structures of display panels in the related art, and will not be described in detail here.

The present disclosure also provides a display apparatus, including the display panel provided by any of the above embodiments. In specific implementation, the display apparatus can be a mobile phone, a tablet computer, a laptop computer, a smart watch, a central control platform, etc., which is not limited here. The display apparatus provided by the embodiment of the present disclosure has the same technical effect as the display panel provided by any of the above embodiments when it is implemented, and will not be described in detail here.

FIG. 9 is a flow chart of a method for manufacturing a display panel provided by an embodiment of the present disclosure.

The present disclosure also provides a method for manufacturing a display panel. As shown in FIG. 9, the method for manufacturing a display panel provided by the present disclosure includes the following steps:
S910: forming an acoustic matching layer on a side of the vibration portion of the ultrasonic transducer facing away from the vibration cavity;
S920: attaching a display substrate to a side of the acoustic matching layer facing away from the ultrasonic transducer.

When manufacturing the display panel provided by the embodiment of the present disclosure, the ultrasonic transducer 100 and the display substrate 300 may be manufactured separately first. Then, the acoustic matching layer 200 is formed on the side of the vibration portion 10 of the ultrasonic transducer 100 facing away from the vibration cavity 130. After the acoustic matching layer 200 is formed, the side of the acoustic matching layer 200 facing away from the ultrasonic transducer 100 is attached to the display substrate 300.

In some embodiments, before forming the acoustic matching layer, a first bonding layer 410 may be formed on the surface of the ultrasonic transducer, and the acoustic matching layer 200 and the ultrasonic transducer 100 are bonded through the first bonding layer 410. Then, a first bonding layer 420 is formed on the side of the acoustic matching layer 200 facing away from the ultrasonic transducer 100, and the acoustic matching layer 200 and the display substrate 300 are bonded through the second bonding layer 420.

In some embodiments, the acoustic matching layer 200 can be directly fabricated on the surface of the ultrasonic transducer 100 by a coating process such as chemical vapor deposition or coating. Then, a bonding layer 400 is fabricated on the side of the acoustic matching layer 200 facing away from the ultrasonic transducer 100, and the acoustic matching layer 200 is bonded to the display substrate 300 through the bonding layer 400.

In some embodiments, a viscous material may be used to make the acoustic matching layer 200. The acoustic matching layer 200 may be directly used for bonding between the ultrasonic transducer 100 and the display substrate 300.

In some embodiments, before forming the acoustic matching layer 200 on the side of the vibration portion 10 of the ultrasonic transducer 100 facing away from the vibration cavity 130, a connection layer 500 may be formed on the surface of the ultrasonic transducer 100. The ultrasonic transducer 100 and the display substrate 300 may be bonded via the connection layer 500.

In some embodiments, the connection layer 500 includes an edge connection structure 510 disposed around the edge region of the ultrasonic transducer 100. In specific implementation, the connection layer 500 can be formed on the surface of the ultrasonic transducer 100 by a coating process such as thin film deposition, inkjet printing, and coating, and then the inner region of the connection layer 500 is etched by etching exposure, development, etching, and other processes, and only the portion disposed around the edge region of the ultrasonic transducer 100 is retained to form the edge connection structure 510. The edge connection structure 510 and the ultrasonic transducer 100 form a housing space, and the material used to form the acoustic matching layer 200 is filled in the housing space by chemical vapor deposition, coating, inkjet printing, perfusion, and other processes to form the acoustic matching layer 200. Then, the display substrate 300 is attached to the side of the acoustic matching layer 200 facing away from the ultrasonic transducer 100, and the ultrasonic transducer 100 and the display substrate 300 are connected via the edge connection structure 510 to form a closed space to seal the acoustic matching layer 200.

In some embodiments, the connection layer 500 includes an edge connection structure 510 disposed around the edge region of the ultrasonic transducer 100, and an internal connection structure 520 located in the region formed by the edge connection structure 510. In specific implementation, the connection layer 500 can be formed on the surface of the ultrasonic transducer 100 by a coating process such as thin film deposition, inkjet printing, coating, etc., and then the connection layer 500 is opened by etching exposure, development, etching, etc. to form a first opening 521 that corresponds to the vibration cavity 130 in an one-to-one manner and penetrates the connection layer 500. When opening the hole, the orthographic projection of the vibration cavity 130 on the display substrate 300 is located within the orthographic projection of the first opening 521 on the display substrate to avoid the connection layer 500 from affecting the ultrasonic transmission. Then, by chemical vapor deposition, coating, inkjet printing, perfusion, etc., the material used to form the acoustic matching layer 200 is filled in the first opening 521 to form the acoustic matching layer 200. Then, the display substrate 300 is attached to the side of the acoustic matching layer 200 facing away from the ultrasonic transducer 100. The ultrasonic transducer 100 and the display substrate 300 are connected via the edge connection structure 510 to form a closed space to seal the acoustic matching layer 200.

In some embodiments, the display substrate 300 further includes a super clean foam layer 330 located on the side of the support layer 310 facing away from the display layer 320. Before the display substrate 300 and the acoustic matching layer 200 are bonded, the super clean foam layer 330 is opened to form a second opening that penetrates the super clean foam layer 330 and exposes the support layer 310. When the display substrate 300 and the acoustic matching layer 200 are bonded, the acoustic matching layer 200 is bonded to the support layer 310 exposed by the second opening.

The specific structure of the display panel provided by the embodiment of the present disclosure has been described in detail in the foregoing content. During specific implementation, the implementation details of the method for manufacturing the display panel provided by the embodiment of the present disclosure can refer to the specific structure of the display panel, which will not be repeated here.

Although the preferred embodiments of the present disclosure have been described, those skilled in the art may make additional changes and modifications to these embodiments once they have learned the basic creative concept. Therefore, the appended claims are intended to be interpreted as including the preferred embodiments and all changes and modifications falling within the scope of the present disclosure.

Obviously, those skilled in the art can make various changes and modifications to the present disclosure without departing from the spirit and scope of the present disclosure. Thus, if these modifications and variations of the present disclosure fall within the scope of the claims of the present disclosure and their equivalents, the present disclosure is also intended to include these modifications and variations.

1. A display panel, comprising:
a display substrate comprising a support layer and a display layer arranged on the support layer;
an ultrasonic transducer arranged on a side of the support layer facing away from the display layer; wherein the ultrasonic transducer comprises a vibration cavity and a vibration portion; the vibration portion is arranged between the vibration cavity and the support layer;
an acoustic matching layer arranged between the vibration portion and the support layer.

2. The display panel as claimed in claim 1, further comprising a bonding layer arranged on at least one side of the acoustic matching layer.

3. The display panel as claimed in claim 2, wherein the bonding layer is arranged between the acoustic matching layer and the support layer; and the acoustic matching layer is in direct contact with the vibration portion.

4. The display panel as claimed in claim 2, wherein the bonding layer comprises a first bonding layer and a second bonding layer; the first bonding layer is arranged between the acoustic matching layer and the support layer; and the second bonding layer is arranged between the acoustic matching layer and the vibration portion.

5. The display panel as claimed in claim 1, wherein the acoustic matching layer is in direct contact with the support layer, and the acoustic matching layer is in direct contact with the vibration portion.

6. The display panel as claimed in claim 5, wherein a material of the acoustic matching layer is a viscous material.

7. The display panel as claimed in claim 5, further comprising a connection layer arranged between the support layer and the ultrasonic transducer;
wherein the connection layer comprises an edge connection structure arranged around an edge region of the ultrasonic transducer; one side of the edge connection structure is bonded to the support layer, and the other side of the edge connection structure is bonded to the ultrasonic transducer to form a closed space; an orthographic projection of the vibration cavity on the display substrate is located within an orthographic projection of the closed space on the display substrate; the acoustic matching layer is filled in the closed space.

8. The display panel as claimed in claim 7, further comprising: at least one support column arranged between the support layer and the ultrasonic transducer; the support column is arranged in a region surrounded by the edge connection structure and is spaced apart from the edge connection structure; an orthographic projection of the support column on the display substrate is located in a region outside the orthographic projection of the vibration cavity on the display substrate.

9. The display panel as claimed in claim 7, wherein the connection layer is arranged as a whole layer; the connection layer further comprises an internal connection structure arranged in an region surrounded by the edge connection structure; the internal connection structure comprises a first opening that penetrates the connection layer in a direction perpendicular to the display substrate; one first opening corresponds to one vibration cavity, and the orthographic projection of the vibration cavity on the display substrate is located within an orthographic projection of the first opening on the display substrate; the acoustic matching layer is arranged in the first opening.

10. The display panel as claimed in claim 1, wherein an acoustic impedance of the acoustic matching layer is between an acoustic impedance of the vibration portion and an acoustic impedance of the support layer.

11. The display panel as claimed in claim 10, wherein the acoustic matching layer is a single-layer structure, and the acoustic impedance of the acoustic matching layer satisfies:
$$Z = \sqrt{{Z}_{1} {Z}_{2}} ;$$
wherein Z represents the acoustic impedance of the acoustic matching layer; Z₁ represents the acoustic impedance of the vibration portion, and Z₂ represents the acoustic impedance of the support layer.

12. The display panel as claimed in claim 11, wherein a shape of the vibration cavity is circular; and the acoustic impedance Z₁ of the vibration portion satisfies:
$${Z}_{1} = \frac{p}{\overline{u}} = j {ωρ}_{2} h \frac{a {k}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) )}{\begin{matrix}{ak}_{1} {k}_{2} ( {k}_{1} {I}_{0} ( {k}_{2} a ) {J}_{1} ( {k}_{1} a ) + {k}_{2} {J}_{0} ( {k}_{1} a ) {I}_{1} ( {k}_{2} a ) ) - \\ 2 ( {k}_{1}^{2} + {k}_{2}^{2} ) {J}_{1} ( {k}_{1} a ) {I}_{1} ( {k}_{2} a )\end{matrix}} ,$$
wherein
$${k}_{1} = \sqrt{\frac{\sqrt{{d}^{2} + 4 {c}_{2} {ω}^{2}} + d}{2 {c}_{2}}} ; {k}_{2} = \sqrt{\frac{\sqrt{{d}^{2} + 4 {c}_{2} {ω}^{2}} - d}{2 {c}_{2}}} ;$$
$$c = \frac{( {E}_{1} + T ) {h}^{2}}{12 {ρ}_{2} ( 1 - {σ}^{2} )} ; d = \frac{T}{{ρ}_{2}} ;$$
p represents an average effective sound pressure on a surface of the vibration portion; ū represents a body velocity of the vibration portion; ω represents a vibration angular frequency of the vibration portion; ρ₂ represents a density of the vibration portion; h represents a thickness of the vibration portion; a represents a radius of the vibration cavity; J₀(x) represents a first type of zero-order Bessel function, x is an independent variable of the first type of zero-order Bessel function; J₁(x) represents a first type of first-order Bessel function, x is an independent variable of the first type of first-order Bessel function; I₀(x) represents a first type of zero-order modified Bessel function, x is the independent variable of the first type of zero-order modified Bessel function; I₁(x) represents a first type of first-order modified Bessel function, x is an independent variable of the first type of first-order modified Bessel function; c₂ represents a sound velocity of an ultrasonic wave propagating in the vibration portion; E₁ represents a Young's modulus of the vibration portion; T represents an internal stress of the vibration portion; σ represents a Poisson's ratio of the vibration portion.

13. The display panel as claimed in claim 11, wherein a thickness of the acoustic matching layer is an odd multiple of a quarter wavelength of an ultrasonic wave emitted by the ultrasonic transducer.

14. The display panel as claimed in claim 10, wherein the acoustic matching layer is a multi-layer structure.

15. The display panel as claimed in claim 14, wherein the acoustic matching layer comprises a first matching layer and a second matching layer stacked in sequence in a direction facing away from the ultrasonic transducer;
wherein an acoustic impedance of the first matching layer satisfies:
$${Z}_{11} = \sqrt[3]{{Z}_{1}^{2} {Z}_{2}} ;$$
an acoustic impedance of the second matching layer satisfies:
$${Z}_{22} = \sqrt[3]{{Z}_{1} {Z}_{2}^{2}} ;$$
wherein Z₁₁ represents the acoustic impedance of the first matching layer; Z₂₂ represents the acoustic impedance of the second matching layer; Z₁ represents the acoustic impedance of the vibration portion; Z₂ represents the acoustic impedance of the support layer.

16. The display panel as claimed in claim 14, wherein a thickness of each layer in the multi-layer structure of the acoustic matching layer is an odd multiple of a quarter wavelength of an ultrasonic wave emitted by the ultrasonic transducer.

17. The display panel as claimed in claim 1, wherein an orthographic projection of the ultrasonic transducer on the display substrate covers at least a partial region of the display substrate.

18. The display panel as claimed in claim 17, wherein the orthographic projection of the ultrasonic transducer on the display substrate covers the partial region of the display substrate;
wherein the display substrate further comprises a super clean foam layer arranged on a side of the support layer facing the ultrasonic transducer; the super clean foam layer comprises a second opening that penetrates the super clean foam layer in a direction perpendicular to the support layer, and the orthographic projection of the ultrasonic transducer on the display substrate is located in the second opening.

19. A display apparatus, comprising the display panel as claimed in claim 1.

20. A method for manufacturing a display panel, comprising:
forming an acoustic matching layer on a side of a vibration portion of an ultrasonic transducer facing away from a vibration cavity;
attaching a display substrate to a side of the acoustic matching layer facing away from the ultrasonic transducer.
